(19) United States
(12) Patent Application Publication
(10) Pub. No.: US 2010/0125633 A1
(43) Pub. Date: May 20, 2010

(54) ON-LINE CONVERSATION SYSTEM, ON-LINE CONVERSATION SERVER, ON-LINE CONVERSATION CONTROL METHOD, AND INFORMATION STORAGE MEDIUM

(75) Inventor: Masayuki Chatani, Tokyo (JP)

Correspondence Address: KATTEN MUCHIN ROSENMAN LLP, 575 MADISON AVENUE, NEW YORK, NY, 10022-2585, US

(73) Assignee: SONY COMPUTER ENTERTAINMENT INC., Tokyo (JP)

(21) Appl. No.: 12/562,403

(22) Filed: Sep. 18, 2009

(30) Foreign Application Priority Data
Nov. 18, 2008 (JP) 2008-294814

(51) Int. Cl. G06F 15/16; G06F 3/048

(52) U.S. Cl. 709/205; 715/757

(57) ABSTRACT

To make it easier to discern a conversation carried out in a virtual space. An on-line conversation control method comprises a conversation group determination step of determining one or more conversation groups (G01 to G03) to which a plurality of user terminals respectively belong; a group conversation data producing step of producing group conversation data representing a conversation carried out by users of the user terminals belonging to each conversation group, based on user voice data received from the user terminals belonging to the conversation group; a group position coordinates determination step of determining position coordinates related to each conversation group, based on position coordinates in a virtual space, related to the user terminals belonging to the conversation group; and a group data sending step of sending, to each of the user terminals, the group conversation data and the position coordinates related to at least one conversation group other than the conversation group to which the user terminal belongs.

### BACKGROUND OF THE INVENTION

1. Field of the Invention

The present invention relates to an on-line conversation system, an on-line conversation server, an on-line conversation control method, and an information storage medium.

2. Description of the Related Art

There is known an on-line game system having many avatars placed in a common virtual space for allowing a user to operate such an avatar, using a game terminal comprising a computer, such as a game device, a personal computer, and so forth. According to some of the systems, a user is requested to input their voice via a game terminal, and the sound of the voice is sent to other game terminals, whereby on-line conversation is realized. In the above, in outputting the sound of conversation at the respective game terminals, a sound image of the sound of voice of a user corresponding to an avatar is localized based on the position of the avatar in the virtual space (see Japanese Patent Laid-open Publication No. 2004-267433). This kind of system can make a user of each game terminal feel as if the user themselves were present as the avatar in the virtual space and communicating with other avatars.

### SUMMARY OF THE INVENTION

However, according to the above described conventional system, when many avatars are placed in the virtual space and conversations on various topics take place in various locations at the same time in the virtual space, a user may not be able to readily discern the respective conversations correctly.

The present invention has been conceived in view of the above, and an object thereof is to provide an on-line conversation system, an on-line conversation server, an on-line conversation control method, and an information storage medium for enabling a user to readily discern conversations taking place in the virtual space.

In order to solve the above described problems, according to one aspect of the present invention, there is provided an on-line conversation system having a server and a plurality of user terminals connected for communication to the server, wherein each of the user terminals comprises a user data sending unit for sending, to the server, user voice data representing voice of a user of the user terminal, the server comprises a user position coordinate obtaining unit for obtaining position coordinates in a virtual space, related to each of the user terminals; a user voice data receiving unit for receiving, from each of the user terminals, the user voice data related to the user terminal; a conversation group determination unit for determining one or more conversation groups to which the plurality of user terminals respectively belong; a group conversation data producing unit for producing group conversation data representing a conversation carried out by users of the user terminals belonging to each conversation group, based on the user voice data received from the user terminals belonging to the conversation group; a group position coordinates determination unit for determining position coordinates related to each conversation group, based on the position coordinates related to the user terminals belonging to the conversation group; and a group data sending unit for sending, to each of the user terminals, the group conversation data and the position coordinates related to at least one conversation group other than the conversation group to which the user terminal belongs, and each of the user terminals further comprises a group data receiving unit for receiving the group conversation data and the position coordinates sent from the group data sending unit; and a reproducing output unit for reproducing the group conversation data received to output, while locating a sound image at a position in accordance with the position coordinates received.

According to another aspect of the present invention, there is provided an on-line conversation server, comprising a conversation group determination unit for determining one or more conversation groups to which a plurality of user terminals respectively belong; a group conversation data producing unit for producing group conversation data representing a conversation carried out by users of the user terminals belonging to each conversation group, based on user voice data received from the user terminals belonging to the conversation group; a group position coordinates determination unit for determining position coordinates related to each conversation group, based on position coordinates in a virtual space, related to the user terminals belonging to the conversation group; and a group data sending unit for sending, to each of the user terminals, the group conversation data and the position coordinates related to at least one conversation group other than the conversation group to which the user terminal belongs.

According to still another aspect of the present invention, there is provided an on-line conversation control method, comprising a conversation group determination step of determining one or more conversation groups to which a plurality of user terminals respectively belong; a group conversation data producing step of producing group conversation data representing a conversation carried out by users of the user terminals belonging to each conversation group, based on user voice data received from the user terminals belonging to the conversation group; a group position coordinates determination step of determining position coordinates related to each conversation group, based on position coordinates in a virtual space, related to the user terminals belonging to the conversation group; and a group data sending step of sending, to each of the user terminals, the group conversation data and the position coordinates related to at least one conversation group other than the conversation group to which the user terminal belongs.

According to yet another aspect of the present invention, there is provided a program for causing a computer to function as a conversation group determination unit for determining one or more conversation groups to which a plurality of user terminals respectively belong; a group conversation data producing unit for producing group conversation data representing a conversation carried out by users of the user terminals belonging to each conversation group, based on user voice data received from the user terminals belonging to the conversation group; a group position coordinates determination unit for determining position coordinates related to each conversation group, based on position coordinates in a virtual space, related to the user terminals belonging to the conversation group; and a group data sending unit for sending, to each of the user terminals, the group conversation data and the position coordinates related to at least one conversation group other than the conversation group to which the user terminal belongs. This program may be stored in a computer readable information storage medium, such as a CD-ROM, a DVD-ROM, and so forth.

### BRIEF DESCRIPTION OF THE DRAWINGS

FIG. 1 is a diagram showing a complete structure of a conversation system according to an embodiment of the present invention;

FIG. 2 is a perspective view showing an example of a virtual space;

FIG. 3 is a diagram showing an image displayed on, and sound output from, a television receiver;

FIG. 4 is a diagram showing a list for conversation group selection;

FIG. 5 is a block diagram showing functions of a game terminal and a game server;

FIG. 6 is a diagram schematically showing content of an avatar position database; and

FIG. 7 is a diagram schematically showing content of a conversation group database.

### DESCRIPTION OF THE PREFERRED EMBODIMENTS

In the following, an embodiment of the present invention will be described in detail with reference to the accompanying drawings.

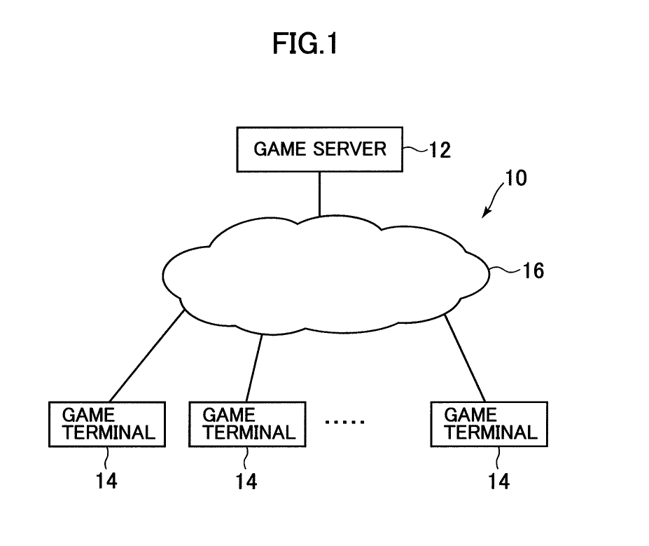

FIG. 1 is a diagram showing a complete structure of an on-line conversation system according to an embodiment of the present invention. As shown in the diagram, the on-line conversation system 10 comprises a game server 12 and a plurality of game terminals 14, all connected to a communication network 16, such as the Internet, or the like. The game server 12 is formed using a computer, such as, e.g., a publicly known server computer, or the like, and each game terminal 14 is formed using a computer, such as, e.g., a game device, a personal computer, or the like. The on-line conversation system 10 is formed as an on-line game system which provides a so-called MMORPG (Massively-Multiplayer On-line Role-Playing Game) so that information about a virtual space can be shared by the plurality of game terminals 14.

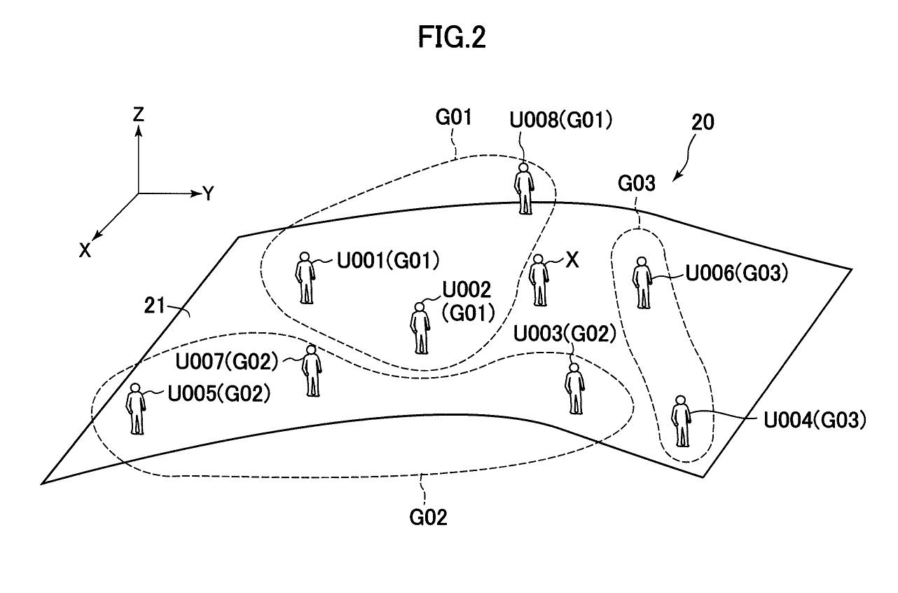

FIG. 2 is a perspective view showing one example of the virtual space. As shown in the diagram, a game stage 21 is placed in the virtual space 20 and avatars U001 to U008 are placed on the game stage 21. Each avatar is correlated to any game terminal 14, and moves on the game stage 21 according to an operation carried out by a user using an operating device equipped to the correlated game terminal 14.

According to this system, when a user speaks into a microphone equipped to the game terminal 14, user voice data (streaming data) representing the voice of the user is produced, and sent to the game server 12. While the respective avatars U001 to U008 are correlated to any of the plurality of conversation groups, user voice data items representing the respective voices of users corresponding to the respective avatars belonging to each conversation group are put into group conversation data (streaming data), or single sound streaming data, in the game server 12 before being sent to the respective game terminals 14. In the above, the coordinates of a representative position of each conversation group are calculated, and sent together with the group conversation data. Note that the representative position may be, e.g., the position coordinates of any avatar belonging to the concerned conversation group (e.g., the first member (host) of the conversation group), or alternatively, an average or a weighted average of the position coordinates of all avatars belonging to the conversation group. In each game terminal 14, the received group conversation data is reproduced and output, while localizing a sound image of the received group conversation data at a position indicated by the received position coordinates of the representative position.

When an avatar newly joins a conversation group, user voice data items corresponding to the respective avatars belonging to the conversation group are sent intact to the game terminal 14 correlated to the newcomer avatar, and reproduced and output in the game terminal 14, while localizing sound images of the respective user voice data items at the respective positions indicated by the respective position coordinates of the avatars corresponding to the respective user voice data items. Note that in this case, the game server 12 does not send group conversation data which includes the same sound of voice to the game terminal 14.

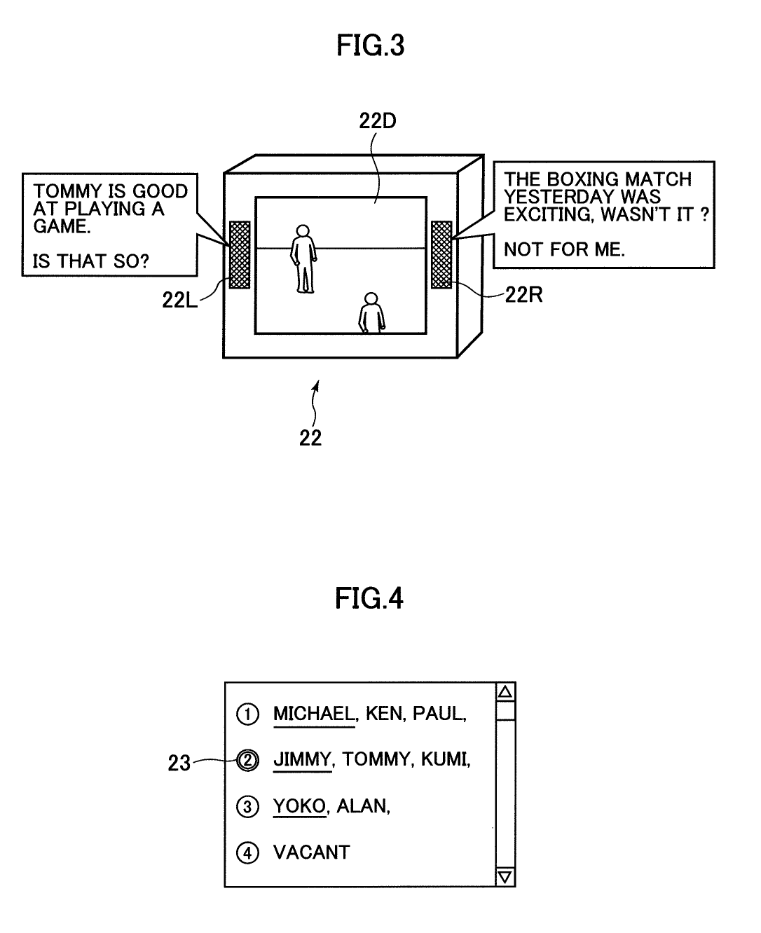

FIG. 3 is a diagram showing a television receiver 22 equipped to a game terminal 14. As shown in the diagram, a picture of the virtual space 20 obtained by viewing the virtual space 20 from the position of an avatar correlated to the game terminal 14 is shown on the screen 22D of the television receiver 22, and the voice of another user as heard at the position of the avatar is output via the left and right speakers 22L, 22R. In the above, the sound of voice related to group conversation data for which a representative position is set on the right side relative to the position of the avatar correlated to the game terminal 14 is output mainly via the right speaker 22R, while the sound of voice related to group conversation data for which a representative position is set on the left side relative to the position of the avatar related to the game terminal 14 is output mainly via the left speaker 22L. With sound being output in this manner, a deficiency where sound of a conversation carried out by a respective conversation group is output scattered right and left, and thus can be hardly discerned by a user, can be prevented.

When a request for joining a conversation is made using an operating device equipped to the game terminal 14, a list shown in FIG. 4 appears on the screen 22D. The list shows the names of avatars which are members of each conversation group, with the name of the first member of the conversation group underlined. A user can designate their desired conversation group using the operating device by moving the cursor 23 shown on the screen 22D. Thereupon, the sound volume at which to reproduce the group conversation data related to the designated conversation group becomes larger. This allows a user to realize which conversation is being carried out by which conversation group. When a user presses a predetermined button on the operating device while designating any conversation group by pointing with the cursor 23, the game terminal 14 sends the group ID of the conversation group to the game server 12. With the above, a user can have their avatar join their desired conversation group.

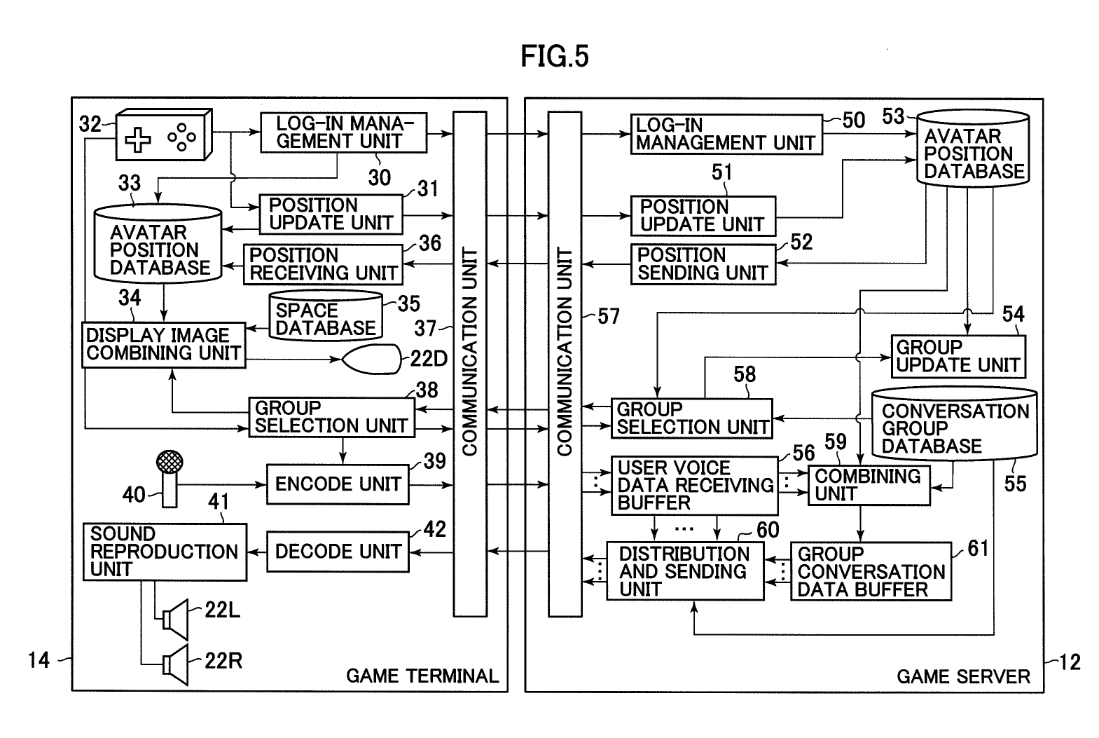

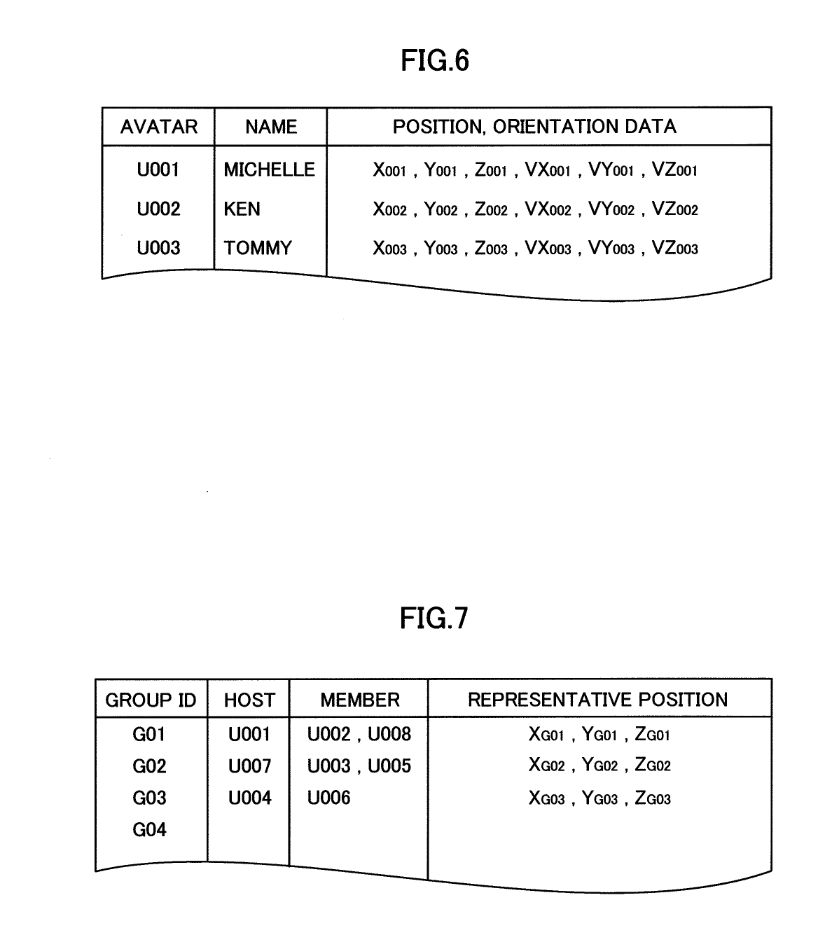

In the following, information processing to be carried out in the on-line conversation system 10 will be described in detail. FIG. 5 is a block diagram showing respective functions of the game terminal 14 and the game server 12. FIG. 6 is a diagram schematically showing the content of an avatar position database held both in the game terminal 14 and the game server 12. FIG. 7 is a diagram schematically showing the content of a conversation group database held in the game server 12.

As shown in FIG. 5, the game terminal 14 comprises a log-in management unit 30, a position update unit 31, an operating device 32, an avatar position database 33, a display image combining unit 34, a space database 35, a position receiving unit 36, a communication unit 37, a group selection unit 38, an encode unit 39, a decode unit 42, and a sound reproduction unit 41. These functions are realized by executing a program in the game terminal 14 which is, e.g., a computer. The program may be downloaded via the communication network 16 from another computer or stored in a computer readable information storage medium, such as a CD-ROM, a DVD-ROM, or the like, and read therefrom to the game terminal 14.

As shown in FIG. 5, the game server 12 comprises a log-in management unit 50, a position update unit 51, a position sending unit 52, an avatar position database 53, a group update unit 54, a conversation group database 55, a user voice data receiving buffer 56, a communication unit 57, a group selection unit 58, a combining unit 59, a distribution and sending unit 60, and a group conversation data buffer 61. These functions also are realized by executing a program in the game server 12 which is, e.g., a computer. The program may be downloaded via the communication network 16 from another computer or stored in a computer readable information storage medium, such as a CD-ROM, a DVD-ROM, or the like, and read therefrom to the game terminal 14.

The log-in management unit 30 carries out a process for allowing a user of the game terminal 14 to log in to the game server 12. Specifically, in response to a log-in operation carried out by the user using the operating device 32, authentication information including the log-in request, the user ID, and the password, the avatar ID, the avatar name, and the initial position and orientation of an avatar corresponding to the user in the virtual space 20 are sent to the game server 12. When user authentication is successfully attained using the authentication information, the log-in management unit 50 of the game server 12 registers the avatar ID, the avatar name, and the initial position and orientation of the avatar corresponding to the user in the avatar position database 53. FIG. 6 is a diagram schematically showing the content of the avatar position database 53. The database 53 is formed using storage means, such as a hard disk memory device, or the like, and stores, for each avatar, an avatar ID, or identification information of an avatar, an avatar name, and a position and orientation of the avatar in the virtual space 20 so as to be correlated to one another. The game terminal 14 also has an avatar position database 33 having content that is similar to that of the avatar position database 53.

The log-in management unit 30 registers the avatar ID, the name, and the initial position and orientation of an avatar correlated to the game terminal 14 in the avatar position database 33. When an operation to move the avatar correlated to the game terminal 14 is carried out, using a cross key, or the like, of the operating device 32, the position update unit 31 updates the position and orientation of the avatar, and the updated position and orientation are stored in the avatar position database 33. The updated position and orientation are also sent to the game server 12. Having received from many game terminals 14 the latest positions and orientations of avatars respectively correlated thereto, the position update unit 51 of the game server 12 stores the received positions and orientations in the avatar position database 53. In this manner, the content of the avatar position database 53 is always kept updated to show the latest state of each avatar. The position sending unit 52 of the game server 12 sends the content of the avatar position database 53 to the respective game terminals 14 every predetermined period of time. Having received the content of the avatar position database 53, the position receiving unit 36 of each game terminal 14 stores the received content in the avatar position database 33. In this manner, the position of the avatar is shared by the game server 12 and many game terminals 14.

The game terminal 14 has a space database 35, where data (polygon data and texture data) describing the shape and external appearance of an object placed in the virtual space 20 is stored. The space database 35 additionally stores the position and orientation of a stationary object, such as a building, or the like, other than an avatar. The display image combining unit 34 produces an image to be displayed on the screen 22D of the television receiver 22, based on the content of the avatar position database 33 and that of the space database 35. Specifically, the position and orientation of an avatar correlated to the game terminal 14 is read, and a viewpoint and a viewing direction which follow the read position and orientation are determined. Then, an image showing a picture obtained by viewing the virtual space 20 from the viewpoint in the viewing direction is formed, using publicly known three dimensional computer graphics technology, and then shown on the screen 22D of the television receiver 22, as shown in FIG. 3.

When an operation to request a conversation group list is carried out using the operating device 32, the group selection unit 38 of the game terminal 14 sends the request to the game server 12. Having received the request, the group selection unit 58 of the game server 12 reads the content of the conversation group database 55, and while referring to the content of the avatar position database 53, converts the avatar ID of an avatar which is a member of each conversation group into an avatar name to thereby produce the information shown in the list of FIG. 4. The information shown in the list is sent to the respective game terminals 14. Then, the group selection unit 38 produces an image of the list, based on the received information of the list, and the display image combining unit 34 places the produced list image on the currently displayed image of the virtual space 20 and displays the resultant image on the screen 22D.

When an operation to select a conversation group is carried out using the operating device 32, the group selection unit 38 sends the group ID of the selected conversation group to the group selection unit 58. The group selection unit 58 forwards the received group ID to the group update unit 54. When there is no host determined yet for the conversation group specified by the group ID, the group update unit 54 registers as a host the avatar ID of the avatar correlated to the game terminal 14 having sent the group ID in the conversation group database 55. Meanwhile, when there is a host already, the avatar ID of the avatar correlated to the game terminal 14 having sent the group ID is registered as a member.

Further, the group update unit 54 determines a representative position of each conversation group, and registers the determined representative position in the conversation group database 55. Specifically, the avatar ID of at least one avatar belonging to each conversation group is read from the conversation group database 55; the position of the avatar is read from the avatar position database; and a representative position is determined, based on the read position. Note that the representative position of a conversion group may be the position of any avatar belonging to the conversation group, as described above, or alternatively, may be the average or weighted average of the positions of some or all of the avatars belonging to that conversation group.

When an avatar correlated to the game terminal 14 newly joins any conversation group, the group selection unit 38 of the game terminal 14 instructs the encode unit 39 to begin sound encoding and transmission. Accordingly, the encode unit 39 encodes the voice sound which is input via the microphone 40 equipped to the game terminal 14 to produce streaming data (user voice data) representing the sound of voice uttered by a user of the game terminal 14. The produced user voice data is sent to the game server 12 and temporarily stored in the user voice data receiving buffer 56. While user voice data sent from other game terminals 14 is also similarly temporarily stored in the user voice data receiving buffer 56, the combining unit 59 obtains the avatar ID's of the avatars belonging to each conversation group, while referring to the content of the conversation group database 55, then reads the user voice data related to the respective avatar ID's related to the game conversion group from the user voice data receiving buffer 56, and combines the read user voice data into single streaming data for the conversation group.

In the above, for example, the respective user voice data items may be mixed at the same mixing ratio to produce streaming data. Streaming data is formed for all conversation groups, and temporarily stored as group conversation data in the group conversation data buffer 61. The distribution and sending unit 60 sends the user voice data stored in the user voice data receiving buffer 56 and the group conversation data stored in the group conversation data buffer 61 to the respective game terminals 14. Specifically, while referring to the content of the conversation group database 55, the distribution and sending unit 60 sends, to a game terminal 14 correlated to an avatar belonging to no conversation group, all of the group conversation data stored in the group conversation data buffer 61 and the representative positions related to the group conversation data, and to a game terminal 14 correlated to an avatar belonging to any conversation group, the group conversation data of a conversation group to which the avatar does not belong and the representative position related to the group conversation data. To a game terminal 14 related to an avatar belonging to any conversation group, user voice data related to other avatars belonging to the same conversation group is additionally sent, together with the position coordinates related to the user voice data.

Having received the data sent from the distribution and sending unit 60 of the game server 12, the decode unit 42 puts the group conversation data and the user voice data into analog data, which is then output by the sound reproduction unit 41 via the left and right speakers 22L, 22R. In the above, a relative position of the representative position related to each group conversation data is calculated, using as a reference the position of the avatar correlated to the game terminal 14, and a sound image of the sound of conversation represented by the group conversation data is localized in the calculated position. Also, a relative position of an avatar related to each user voice data is calculated, using as a reference the position of the avatar correlated to the game terminal 14, and a sound image of the sound of voice represented by the user voice data is localized in the calculated position.

Note that in the case where a direction in the virtual space 20 is input using the operating device 32, the sound reproduction unit 41 may select one conversation group from the conversation groups, based on the direction input and the representative positions of the respective conversation groups, and reproduce the group conversation data of the selected conversation group at a weighted volume. For example, a straight line extending from the position of the avatar correlated to the game terminal 14 in the direction which is input using the operating device 32 is calculated, and a representative position located closest to the straight line is selected. Then, the sound volume for reproducing the group conversation data related to the selected representative position is increased by a predetermined rate. With this arrangement, a user can look for a conversation group which the user wishes to join, while inputting their desired direction in the virtual space 20 to listen to a conversation carried out by a conversation group having a representative position set in the direction input.

According to this embodiment, the sound of conversation carried out by a conversation group other than that to which an avatar operated by a user belongs is reproduced in a manner which makes the sound seem to be heard as if the conversation were made by avatars gathered in the representative position of the conversation group in the virtual space 20. This makes it easier for a user to discern the respective conversations, compared to a case in which the avatars are speaking at their respective positions.

What is claimed is:

1. An on-line conversation system having a server and a plurality of user terminals connected for communication to the server, wherein
each of the user terminals comprises user data sending means for sending, to the server, user voice data representing voice of a user of the user terminal,
the server comprises
user position coordinate obtaining means for obtaining position coordinates in a virtual space, related to each of the user terminals;
user voice data receiving means for receiving, from each of the user terminals, the user voice data related to the user terminal;
conversation group determination means for determining one or more conversation groups to which the plurality of user terminals respectively belong;
group conversation data producing means for producing group conversation data representing a conversation carried out by users of the user terminals belonging to each conversation group, based on the user voice data received from the user terminals belonging to the conversation group;
group position coordinates determination means for determining position coordinates related to each conversation group, based on the position coordinates related to the user terminals belonging to the conversation group; and
group data sending means for sending, to each of the user terminals, the group conversation data and the position coordinates related to at least one conversation group other than the conversation group to which the user terminal belongs, and
each of the user terminals further comprises
group data receiving means for receiving the group conversation data and the position coordinates sent from the group data sending means; and
reproducing output means for reproducing the group conversation data received and performing output, while locating a sound image at a position in accordance with the position coordinates received.

2. The on-line conversation system according to claim 1, wherein
the group data sending means sends, to each of the user terminals, the user voice data and the position coordinates related to another user terminal belonging to the conversation group to which the user terminal belongs,
the group data receiving means receives the user voice data and the position coordinates sent from the group data sending means, and
the reproducing output means reproduces the user voice data received and performs output, while locating a sound image at a position in accordance with the position coordinates received.

3. The on-line conversation system according to claim 1, wherein
each of the user terminals further comprises direction input means for inputting a direction in the virtual space, and
the reproducing output means reproduces any of the group conversation data selected according to the direction which is input using the direction input means to output at a weighted sound volume.

4. An on-line conversation server, comprising:
conversation group determination means for determining one or more conversation groups to which a plurality of user terminals respectively belong;
group conversation data producing means for producing group conversation data representing a conversation carried out by users of the user terminals belonging to each conversation group, based on user voice data received from the user terminals belonging to the conversation group;
group position coordinates determination means for determining position coordinates related to each conversation group, based on position coordinates in a virtual space, related to the user terminals belonging to the conversation group; and
group data sending means for sending, to each of the user terminals, the group conversation data and the position coordinates related to at least one conversation group other than the conversation group to which the user terminal belongs.

5. An on-line conversation control method, comprising:
a conversation group determination step of determining one or more conversation groups to which a plurality of user terminals respectively belong;
a group conversation data producing step of producing group conversation data representing a conversation carried out by users of the user terminals belonging to each conversation group, based on user voice data received from the user terminals belonging to the conversation group;
a group position coordinates determination step of determining position coordinates related to each conversation group, based on position coordinates in a virtual space, related to the user terminals belonging to the conversation group; and
a group data sending step of sending, to each of the user terminals, the group conversation data and the position coordinates related to at least one conversation group other than the conversation group to which the user terminal belongs.

6. An information storage medium storing a program for causing a computer to function as:
conversation group determination means for determining one or more conversation groups to which a plurality of user terminals respectively belong;
group conversation data producing means for producing group conversation data representing a conversation carried out by users of the user terminals belonging to each conversation group, based on user voice data received from the user terminals belonging to the conversation group;
group position coordinates determination means for determining position coordinates related to each conversation group, based on position coordinates in a virtual space, related to the user terminals belonging to the conversation group; and
group data sending means for sending, to each of the user terminals, the group conversation data and the position coordinates related to at least one conversation group other than the conversation group to which the user terminal belongs.
